(19) United States
(12) Patent Application Publication
(10) Pub. No.: US 2026/0131686 A1
(43) Pub. Date: May 14, 2026

(54) METHOD AND APPARATUS FOR GUIDING FAST CHARGING DEMANDS OF ELECTRIC VEHICLES, DEVICE, AND MEDIUM

(71) Applicants: STATE GRID JIANGSU ELECTRIC POWER COMPANY RESEARCH INSTITUTE, Nanjing (CN); STATE HRID JIANGSU ELECTRIC POWER CO, LTD., Nanjing (CN)

(72) Inventors: Huachun HAN, Nanjing (CN); Mingshen WANG, Nanjing (CN); Xiaodong YUAN, Nanjing (CN); Shukang LV, Nanjing (CN); Huiyu MIAO, Nanjing (CN); Wenjun RUAN, Nanjing (CN); Yi PAN, Nanjing (CN); Haiqing GAN, Nanjing (CN); Xize JIAO, Nanjing (CN); Fei ZENG, Nanjing (CN)

(21) Appl. No.: 19/060,491

(22) Filed: Feb. 21, 2025

(30) Foreign Application Priority Data
Nov. 11, 2024 (CN) 202411597716.4

(51) Int. Cl. B60L 53/64; B60L 53/10; B60L 53/63; G06Q 30/0201; G06Q 50/06

(52) U.S. Cl. CPC B60L 53/64; B60L 53/11; B60L 53/63; G06Q 30/0206; G06Q 50/06

(57) ABSTRACT

The invention relates to the technical field of electric vehicle charging guidance, in particular to a method and apparatus for guiding fast charging demands of electric vehicles, a device, and a medium. The method includes: establishing a dynamic traffic network with real-time updates; constructing a road traffic impedance model and an electric vehicle power consumption model; developing a private vehicle travel behavior model and a ride-hailing vehicle travel behavior model; creating quantitative indicators for user charging satisfaction; proposing charging choice models for different types of electric vehicles; and predicting charging loads at charging stations during various time periods and proposing a dynamic pricing strategy with the goal of minimizing load fluctuations at the charging stations. The distribution of fast charging loads in both time and space is optimized based on the travel patterns of different types of electric vehicles, including private vehicles and ride-hailing vehicles.

This application is the National Stage Application of PCT/CN2024/132176, filed on Nov. 15, 2024, which claims priority to Chinese Patent Application No. 202411597716.4, filed on Nov. 11, 2024, which is incorporated by reference for all purposes as if fully set forth herein.

### TECHNICAL FIELD

The invention relates to the technical field of electric vehicle charging guidance, in particular to a method and apparatus for guiding fast charging demands of electric vehicles, a device, and a medium.

### BACKGROUND OF THE INVENTION

Electric vehicle charging stations typically offer fast and slow charging options. Fast charging, in contrast to slow charging, is characterized by a high power demand in a short time, which can lead to significant negative effects on the power distribution network. Therefore, it is of great significance to guide users to evenly disperse the electric vehicles to each charging station for fast charging by various means, so as to change the temporal and spatial distribution of fast charging load for maintaining the voltage stability of distribution network. The main purpose of guiding electric vehicle charging is to alleviate congestion at charging stations and improve the utilization of charging facilities.

Currently, the guidance for electric vehicle charging mainly focuses on modifying electricity prices to affect users' charging choices, typically by lowering prices to encourage charging during certain times. However, this method has significant limitations in practical implementation. Merely adjusting prices does not adequately consider the actual travel needs and behavior patterns of electric vehicle users, which hampers accurate guidance for load distribution during charging. Therefore, existing charging guidance measures have limited effectiveness in improving the utilization of charging facilities and alleviating congestion. There is an urgent need for more detailed behavioral analysis and quantification of charging satisfaction for different user groups, in conjunction with appropriate pricing strategies for optimization.

The information disclosed in Background Art is only intended to facilitate the understanding of the general background of the invention, and should not be taken as an acknowledgement or any form of implication that this information constitutes the prior art known to those of ordinary skill in the art.

### SUMMARY OF THE INVENTION

The invention provides a method and apparatus for guiding fast charging demands of electric vehicles, a device, and a medium, effectively addressing the issues in the background art.

To achieve the above objective, the invention adopts the following technical scheme. A method for guiding fast charging demands of electric vehicles comprises the following steps:
S10, acquiring information on roads, traffic, and charging stations to establish a dynamic traffic network with real-time updates;
S20, constructing a road traffic impedance model and an electric vehicle power consumption model by utilizing the dynamic traffic network and taking into account the road travel time and speed of electric vehicles under different traffic conditions;
S30, simulating the travel behavior of electric vehicles based on the road traffic impedance model and the electric vehicle power consumption model, classifying electric vehicles into private vehicles and ride-hailing vehicles based on different travel patterns, and developing a private vehicle travel behavior model and a ride-hailing vehicle travel behavior model;
S40, creating quantitative indicators for user charging satisfaction by utilizing the private vehicle travel behavior model and the ride-hailing vehicle travel behavior model and taking into account travel time, charging prices, and power consumption;
S50, proposing charging choice models for different types of electric vehicles based on the quantitative indicators for user charging satisfaction and a charging station queuing system; and
S60, based on the charging choice models and the charging station queuing system, predicting charging loads at charging stations during various time periods and proposing a dynamic pricing strategy with the goal of minimizing load fluctuations at the charging stations.

Further, in S20, the road traffic impedance model comprises:

$${R}_{l} = \frac{2 {T}_{0 , l} ( 1 + \sqrt{1 + \frac{{Q}_{l}}{{C}_{l}}} )}{\frac{{Q}_{l}}{{C}_{l}}} + τ ( \frac{{L}_{l}}{{N}_{l}} ) ;$$

where Rₗ is the total travel time for road segment l, T_{0,l} is the travel time for road segment l when it is clear, Q₁ is the traffic volume on road segment l, Cₗ is the actual traffic capacity of road segment l, Lₗ is the length of road segment l, Nₗ is the number of roadside vehicles on road segment l, and τ is the influence coefficient of roadside vehicles on the traffic flow of road segment.

Further, in S20, the electric vehicle power consumption model comprises:

$${E}_{lose , l} = {L}_{l} ( a - {bV}_{l} + \frac{c}{{V}_{l}} ) ;$$

where E_{lose,l} is the power consumption of electric vehicles on road segment l, Vₗ is the average speed of electric vehicles traveling on road segment l, with different speeds corresponding to different road grades and conditions, Lₗ is the length of road segment l, and a, b and c are power consumption coefficients.

Further, in S30, classifying electric vehicles into private vehicles and ride-hailing vehicles based on different travel patterns and developing a private vehicle travel behavior model and a ride-hailing vehicle travel behavior model comprises:
S31, determining the travel behavior of private vehicles, including the use of travel chains that start and end at residential areas to describe the travel behavior of private vehicles, the first travel time and duration for each type of travel chain following a normal distribution;
S32, determining the travel behavior of ride-hailing vehicles, including the use of a travel state transition matrix to describe the travel behavior of ride-hailing vehicles, the first travel time and number of trips for ride-hailing vehicles also following a normal distribution;
S33, based on the travel behavior of private vehicles and the travel behavior of ride-hailing vehicles, planning routes for private vehicles and ride-hailing vehicles, specifically comprising:
planning routes for private vehicles with the aim of minimizing driving time; and
planning routes for ride-hailing vehicles with the aim of minimizing electric vehicle travel distance during passenger trips, and minimizing electric vehicle energy consumption or driving time during empty trips; and
S34, based on the planned routes for private vehicles and ride-hailing vehicles, calculating the arrival time and remaining battery power for electric vehicles.

Further, in S34, a model for calculating the arrival time and remaining battery power for electric vehicles comprises:

$${t}_{h , p}^{arrive} = {t}_{h , p - 1}^{leave} + {\sum }_{( i , j ) ∈ {Ω}_{p - 1 , p}} {t}_{i , j}^{travel} ;$$

$${E}_{h , p}^{arrive} = {E}_{h , p - 1}^{leave} - {\sum }_{( i , j ) ∈ {Ω}_{p - 1 , p}} {E}_{l o se , i , j} ;$$

where

$${t}_{h , p}^{arrive}$$

is the time when the h^{th} electric vehicle arrives at activity location p,

$${t}_{h , p - 1}^{leave}$$

is the time when the h^{th} electric vehicle departs from activity location p−1,

$${t}_{i , j}^{t r avel}$$

is the travel time for the road segment from node i to node j, Ω_{p-1,p} is a set of road segments on the path from activity location p−1 to activity location p,

$${E}_{h , p}^{arrive}$$

is the remaining battery power of the h^{th} electric vehicle when it arrives at activity location p,

$${E}_{h , p - 1}^{leave}$$

is the remaining battery power of the h^{th} electric vehicle when it departs from activity location p−1, and E_{lose,i.j} is the power consumption for the road segment from node i to node j.

Further, in S40, creating quantitative indicators for user charging satisfaction by taking into account travel time, charging prices, and power consumption comprises:

$${f}_{CSR , k} = α {f}_{1 , k} + β {f}_{2 , k} + γ {f}_{3 , k} ;$$

where f_{CSR,k} represents the comprehensive charging satisfaction of electric vehicles at charging station k, f_{1,k} represents the satisfaction with charging travel time for electric vehicles arriving at charging station k, f_{2,k} represents the satisfaction with charging travel time for electric vehicles arriving at charging station k, f_{3,k} represents the satisfaction with charging price for charging at charging station k for electric vehicles, and α, β and γ are weight coefficients for user charging satisfaction indicators, totaling 1.

Further, in S50, proposing charging choice models for different types of electric vehicles based on the quantitative indicators for user charging satisfaction and a charging station queuing system comprises:
S51, assessing the charging demand of private vehicles, including the scenario where, before each trip, if the remaining battery power of the electric vehicle is insufficient to reach the next destination, the user will choose to detour to a charging station for charging, and if fast charging is required during travel between two stops, the private vehicle will detour to a charging station for charging;
S52, assessing the charging demand of ride-hailing vehicles, including the scenario where, ride-hailing vehicles in the process of travel, if the remaining battery power falls below a certain threshold and the ride-hailing vehicle is in an unoccupied state, the ride-hailing vehicle will head to a charging station for charging before picking up passengers;
S53, based on the charging demand assessments for private vehicles and ride-hailing vehicles, selecting the most suitable charging station using the quantitative indicators for user charging satisfaction, and calculating charging duration and load demands based on an initial battery level and charging station conditions; and
S54, based on the charging duration and load demands, determining, by the charging station queuing system, the order of queuing and charging for electric vehicles based on a first-come, first-served principle.

Further, in S60, based on the charging choice models and the charging station queuing system, predicting charging loads at charging stations during various time periods and proposing a dynamic pricing strategy with the goal of minimizing load fluctuations at the charging stations comprises:
S61, constructing a charging station load prediction model to obtain a predicted charging load for each charging station;
S62, based on the maximum charging load capacity that each charging station is able to accommodate, normalizing the predicted charging load for each charging station to the maximum capacity, and calculating an average predicted load for the charging stations;
S63, when a difference between the predicted charging load for each charging station and the average predicted load is less than or greater than an adjustment threshold, adjusting the charging prices at the charging stations; and
S64, based on the adjustment to the charging prices at the charging stations, optimizing a charging price adjustment step size using a particle swarm optimization algorithm with a compression factor.

Further, in S62, a model for calculating an average predicted load for the charging stations comprises:

$${L}_{mean , t}^{predict} = \frac{{\sum }_{k = 1}^{K} {L}_{k , t}^{predict} {σ}_{k}}{K} ;$$

$${σ}_{k} = \frac{max \{ {q}_{1} , {q}_{2} , … , {q}_{K} \}}{{q}_{k}} ;$$

where

$${L}_{mean , t}^{predict}$$

is the average predicted load demand for time period t,

$${L}_{k , t}^{predict}$$

is the predicted load demand for charging station k during time period t, σₖ is the normalization factor for charging station k, which equals 1 when the charging load capacity of charging station k is equal to the maximum charging load capacity among all charging stations, K is the total number of charging stations, and qₖ is the number of charging piles within charging station k.

Further, in S63, when a difference between the predicted charging load for each charging station and the average predicted load is less than or greater than an adjustment threshold, a model for adjusting the charging prices at the charging stations comprises:

$${C}_{k , t} = \{ \begin{matrix}{C}_{k , t} + Δ {c}_{k} & {L}_{k , t}^{predict} {σ}_{k} - {L}_{mean , t}^{predict} > ε {L}_{mean , t}^{predict} \\ {C}_{k , t} & \vert {L}_{k , t}^{predict} {σ}_{k} - {L}_{mean , t}^{predict} \vert , , ε {L}_{mean , t}^{predict} \\ {C}_{k , t} - Δ {c}_{k} & {L}_{k , t}^{predict} {σ}_{k} - {L}_{mean , t}^{predict} < - ε {L}_{mean , t}^{predict}\end{matrix} ;$$

where C_{k,t} is the charging price for charging station k during time period t, Δcₖ is the charging price adjustment step size, ε is the dead-time coefficient,

$${L}_{mean , t}^{predict}$$

is the average predicted load demand for time period t,

$${L}_{k , t}^{predict}$$

is the predicted load demand for charging station k during time period t, and σₖ is the normalization factor for charging station k, which equals 1 when the charging load capacity of charging station k is equal to the maximum charging load capacity among all charging stations.

The invention further provides a fast-charging demand guidance apparatus for guiding the charging preferences of electric vehicle users, which uses the method as described above and comprises:
a dynamic traffic network establishment unit for acquiring information on roads, traffic, and charging stations to establish a dynamic traffic network with real-time updates;
an impedance and power consumption model construction unit for constructing a road traffic impedance model and an electric vehicle power consumption model by utilizing the dynamic traffic network and taking into account the road travel time and speed of electric vehicles under different traffic conditions;
a travel behavior model development unit for simulating the travel behavior of electric vehicles based on the road traffic impedance model and the electric vehicle power consumption model, classifying electric vehicles into private vehicles and ride-hailing vehicles based on different travel patterns, and developing a private vehicle travel behavior model and a ride-hailing vehicle travel behavior model;
a user satisfaction construction unit for creating quantitative indicators for user charging satisfaction by utilizing the private vehicle travel behavior model and the ride-hailing vehicle travel behavior model and taking into account travel time, charging prices, and power consumption;
a charging choice model construction unit for proposing charging choice models for different types of electric vehicles based on the quantitative indicators for user charging satisfaction and a charging station queuing system; and
a dynamic pricing strategy unit for, based on the charging choice models and the charging station queuing system, predicting charging loads at charging stations during various time periods and proposing a dynamic pricing strategy with the goal of minimizing load fluctuations at the charging stations.

The invention further provides a computer device, comprising a memory, a processor and a computer program stored in the memory and executable on the processor, wherein the processor, when executing the computer program, implements the method as described above.

The invention further provides a storage medium on which a computer program is stored, wherein the computer program, when executed by a processor, implements the method as described above.

The invention has the following beneficial effects.

The invention, by taking into account the real-time changes in traffic flow and the travel behavior patterns of different types of electric vehicles, accurately depicts the travel and charging behaviors of various electric vehicles, establishes the quantitative indicators for user charging satisfaction based on the actual needs of different users, and effectively guides electric vehicles toward fast charging by using an appropriate charging pricing strategy. The system can address potential peak charging load issues at specific times and locations for different travel patterns of electric vehicles, such as private vehicles and ride-hailing vehicles, optimizing the spatial and temporal distribution of fast charging loads. This effectively alleviates the pressure on a power distribution network during peak charging times, maintaining the stability of the grid voltage. Additionally, the invention lays an important technical foundation for further research into comprehensive charging guidance strategies that consider both slow and fast charging of electric vehicles.

### BRIEF DESCRIPTION OF DRAWINGS

In order to more clearly explain the embodiments of the invention or the technical scheme in the prior art, the following will briefly introduce the drawings needed in the description of the embodiments or the prior art. Obviously, the drawings in the following description are only some embodiments of the invention. For those of ordinary skill in the art, other drawings can be obtained according to the provided drawings without paying creative labor.

FIG. 1 illustrates the process of a method for guiding fast charging demands of electric vehicles;

FIG. 2 is a flowchart of a method for guiding fast charging demands of electric vehicles;

FIG. 3 is a flowchart of private vehicle charging demand prediction;

FIG. 4 is a flowchart of ride-hailing vehicle charging demand prediction;

FIG. 5 is a flowchart of a dynamic pricing process for charging stations;

FIG. 6 is a structural diagram of a fast-charging demand guidance apparatus for guiding the charging preferences of electric vehicle users; and

FIG. 7 is a structural diagram of a computer device.

### DETAILED DESCRIPTION OF THE INVENTION

The technical schemes in the embodiments of the present invention are clearly and completely described in the following with reference to the drawings in the embodiments of the present invention. It is obvious that the described embodiments are only some of the embodiments of the present invention and are not all the embodiments thereof.

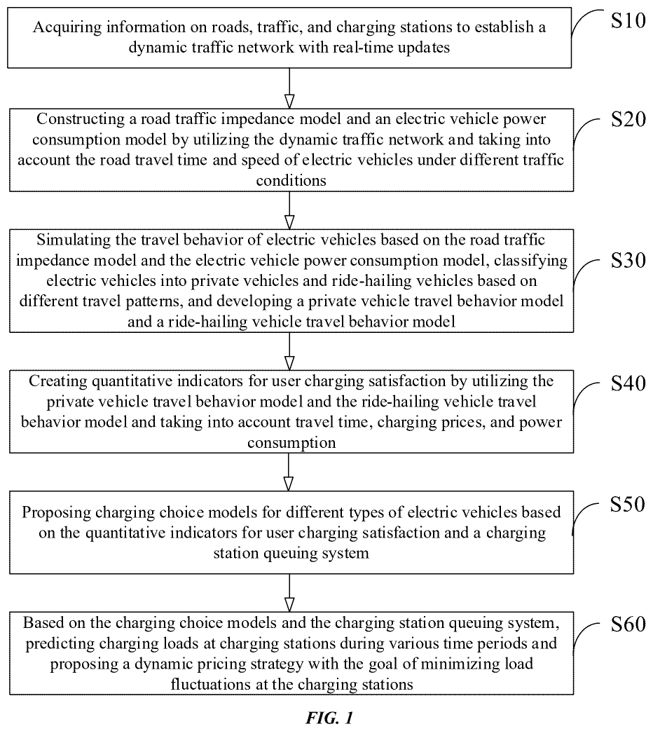

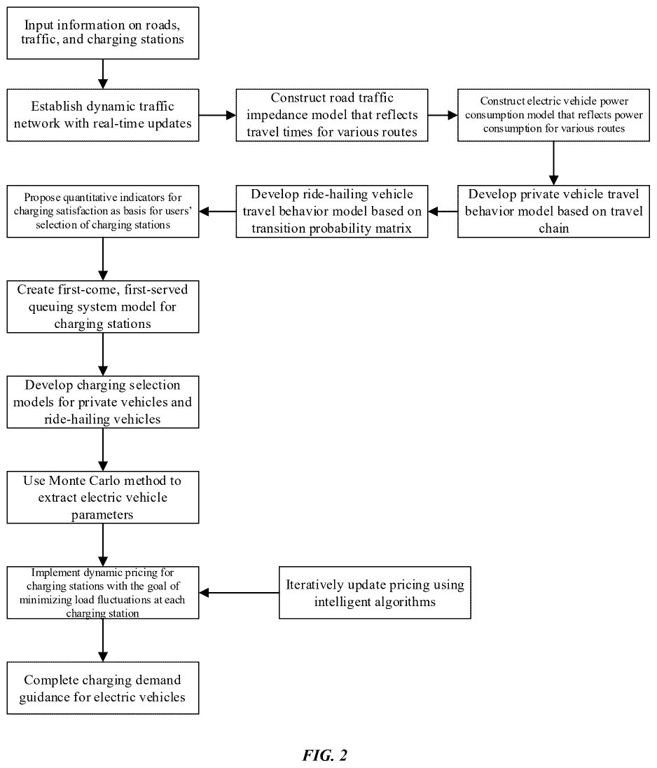

As shown in FIGS. 1-5, a method for guiding fast charging demands of electric vehicles comprises:
S10, acquiring information on roads, traffic, and charging stations to establish a dynamic traffic network with real-time updates;
S20, constructing a road traffic impedance model and an electric vehicle power consumption model by utilizing the dynamic traffic network and taking into account the road travel time and speed of electric vehicles under different traffic conditions;
S30, simulating the travel behavior of electric vehicles based on the road traffic impedance model and the electric vehicle power consumption model, classifying electric vehicles into private vehicles and ride-hailing vehicles based on different travel patterns, and developing a private vehicle travel behavior model and a ride-hailing vehicle travel behavior model;
S40, creating quantitative indicators for user charging satisfaction by utilizing the private vehicle travel behavior model and the ride-hailing vehicle travel behavior model and taking into account travel time, charging prices, and power consumption;
S50, proposing charging choice models for different types of electric vehicles based on the quantitative indicators for user charging satisfaction and a charging station queuing system; and
S60, based on the charging choice models and the charging station queuing system, predicting charging loads at charging stations during various time periods and proposing a dynamic pricing strategy with the goal of minimizing load fluctuations at the charging stations.

The invention, by taking into account the real-time changes in traffic flow and the travel behavior patterns of different types of electric vehicles, accurately depicts the travel and charging behaviors of various electric vehicles, establishes the quantitative indicators for user charging satisfaction based on the actual needs of different users, and effectively guides electric vehicles toward fast charging by using an appropriate charging pricing strategy. The system can address potential peak charging load issues at specific times and locations for different travel patterns of electric vehicles, such as private vehicles and ride-hailing vehicles, optimizing the spatial and temporal distribution of fast charging loads. This effectively alleviates the pressure on a power distribution network during peak charging times, maintaining the stability of the grid voltage. Additionally, the invention lays an important technical foundation for further research into comprehensive charging guidance strategies that consider both slow and fast charging of electric vehicles.

By constructing the road traffic impedance model and the electric vehicle power consumption model, this approach takes into account the travel time and power consumption of electric vehicles under different traffic conditions. This enables the charging guidance strategy to more accurately predict the remaining battery power and range of the vehicles, thereby assisting users in planning their charging time and location more scientifically.

By distinguishing between different types of electric vehicles, such as private vehicles and ride-hailing vehicles, and constructing respective travel behavior models, this approach can provide personalized guidance for the travel demands and charging behaviors of various electric vehicle types. It offers more tailored charging guidance strategies for different types of electric vehicle users, ensuring that the guidance measures adapt to the diverse charging habits and travel needs of users, thus addressing the shortcomings of existing methods that inadequately consider differentiated user needs.

By creating the quantitative indicators for user charging satisfaction that comprehensively consider factors such as travel time, charging prices, and power consumption, the overall charging experience for users can be significantly enhanced. Users will no longer choose charging stations based solely on a single factor (like price), but will make intelligent decisions based on comprehensive satisfaction, improving comfort and satisfaction during the charging process.

By proposing the dynamic charging station choice models based on user charging satisfaction and the charging station queuing system, electric vehicle users are guided to choose suitable charging stations according to their actual needs. This helps avoid overcrowding at certain charging stations, optimizes the allocation of charging resources, reduces excessive congestion during peak times, and enhances the utilization of charging facilities, allowing more users to complete charging more efficiently and addressing the issue of uneven resource allocation at existing charging stations due to user congestion.

By predicting the charging loads at charging stations during various time periods and proposing the dynamic pricing strategy with the goal of minimizing load fluctuations at the charging stations based on the charging choice models and the charging station queuing system, users are guided to charge during off-peak hours through price regulation, thereby balancing the loads among charging stations, reducing the power fluctuation pressure on a power distribution network caused by fast charging, and ensuring the stable operation of a power grid.

As a preferred option for the above embodiment, in S20, the road traffic impedance model comprises:

$${R}_{l} = \frac{2 {T}_{0 , l} ( 1 + \sqrt{1 + \frac{{Q}_{l}}{{C}_{l}}} )}{\frac{{Q}_{l}}{{C}_{l}}} + τ ( \frac{{L}_{l}}{{N}_{l}} ) ;$$

where Rₗ is the total travel time for road segment l, T_{0,l} is the travel time for road segment l when it is clear,

$$\frac{{Q}_{l}}{{C}_{l}}$$

is the traffic load on road segment l, Q₁ is the traffic volume on road segment l, Cₗ is the actual traffic capacity of road segment l, Lₗ is the length of road segment l, Nₗ is the number of roadside vehicles on road segment l, and τ is the influence coefficient of roadside vehicles on the traffic flow of road segment.

This model not only considers the travel time during normal and smooth traffic conditions but also incorporates actual factors such as traffic load and road length, allowing it to dynamically reflect road resistance under different traffic conditions. By using traffic load and the influence coefficient τ of roadside vehicles, this approach can effectively adapt to the travel demands of electric vehicles in various complex road situations, particularly providing more realistic time estimates in congested or narrow roads.

In this embodiment, in S20, the electric vehicle power consumption model comprises:

$${E}_{lose , l} = {L}_{l} ( a - {bV}_{l} + \frac{c}{{V}_{l}} ) ;$$

where E_{lose,l} is the power consumption of electric vehicles on road segment l, Vₗ is the average speed of electric vehicles traveling on road segment l, with different speeds corresponding to different road grades and conditions, Lₗ is the length of road segment l, and a, b and c are power consumption coefficients.

The model takes into account variations in driving speed caused by different road grades and conditions, allowing it to flexibly adapt to various real-world scenarios. This closer alignment with the energy consumption performance of electric vehicles in real environments enables precise energy calculation, providing electric vehicle users with a comprehensive energy consumption estimate when choosing different routes. It helps users select the most energy-efficient driving path or charging station based on the current battery level.

As a preferred option for the above embodiment, in S30, classifying electric vehicles into private vehicles and ride-hailing vehicles based on different travel patterns and developing a private vehicle travel behavior model and a ride-hailing vehicle travel behavior model comprises:
S31, determining the travel behavior of private vehicles, including the use of travel chains that start and end at residential areas to describe the travel behavior of private vehicles, the first travel time and duration for each type of travel chain following a normal distribution;
S32, determining the travel behavior of ride-hailing vehicles, including the use of a travel state transition matrix to describe the travel behavior of ride-hailing vehicles, the first travel time and number of trips for ride-hailing vehicles also following a normal distribution, and the travel state transition matrix being expressed as follows:

$$R W O \\ {p}_{t} = \begin{matrix}R \\ W \\ O\end{matrix} [ \begin{matrix}{p}_{11} & {p}_{12} & {p}_{13} \\ {p}_{21} & {p}_{22} & {p}_{23} \\ {p}_{31} & {p}_{32} & {p}_{33}\end{matrix} ] ;$$

where pₜ is the state transition matrix of electric vehicles for each time period within a 24-hour day, pₘₙ (m,n=1,2,3) is the transition probability of electric vehicles between various functional areas, and R, W and O represent residential areas, work areas, and other areas such as commercial zones respectively;
S33, based on the travel behavior of private vehicles and the travel behavior of ride-hailing vehicles, planning routes for private vehicles and ride-hailing vehicles, specifically comprising:
planning routes for private vehicles with the aim of minimizing driving time; and
planning routes for ride-hailing vehicles with the aim of minimizing electric vehicle travel distance during passenger trips, and minimizing electric vehicle energy consumption or driving time during empty trips; and
S34, based on the planned routes for private vehicles and ride-hailing vehicles, calculating the arrival time and remaining battery power for electric vehicles.

There are significant differences in travel patterns between private vehicles and ride-hailing vehicles. By constructing separate models for each, their behavioral characteristics can be more accurately depicted. Private vehicles primarily follow fixed travel chains, while ride-hailing vehicles involve more random factors. The use of a state transition matrix allows for better simulation of the complex operational patterns of ride-hailing services. Personalized behavioral modeling aids in providing more precise charging guidance for different user groups, avoiding the neglect of user needs inherent in a single model, thereby enhancing the flexibility and accuracy of charging guidance.

In S34, a model for calculating the arrival time and remaining battery power for electric vehicles comprises:

$${t}_{h , p}^{arrive} = {t}_{h , p - 1}^{leave} + {\sum }_{( i , j ) ∈ {Ω}_{p - 1 , p}} {t}_{i , j}^{travel} ;$$

$${E}_{h , p}^{arrive} = {E}_{h , p - 1}^{leave} - {\sum }_{( i , j ) ∈ {Ω}_{ρ - 1 , p}} {E}_{lose , i , j} ;$$

where

$${t}_{h , p}^{arrive}$$

is the time when the h^{th} electric vehicle arrives at activity location p,

$${t}_{h , p - 1}^{leave}$$

is the time when the h^{th} electric vehicle departs from activity location p−1,

$${t}_{i , j}^{travel}$$

is the travel time for the road segment from node i to node j, Ω_{p-1,p} is a set of road segments on the path from activity location p−1 to activity location p,

$${E}_{h , p}^{arrive}$$

is the remaining battery power of the h^{th} electric vehicle when it arrives at activity location p,

$${E}_{h , p - 1}^{leave}$$

is the remaining battery power of the h^{th} electric vehicle when it departs from activity location p−1, and E_{lose,i,j} is the power consumption for the road segment from node i to node j.

This model integrates route planning, travel time, and energy consumption for electric vehicles, providing high-precision foundational data for the charging guidance system. This enables the charging guidance system to dynamically adjust charging recommendations based on the real-time remaining battery power and travel time of electric vehicles. Additionally, it offers users intelligent charging station selections and optimal charging timings. With accurate arrival time prediction, the system can better guide users in adjusting their charging schedules, minimizing wasted time on the journey. Precise energy consumption calculation allows users to choose the most suitable charging stations and timings based on the actual energy usage of electric vehicles, avoiding premature charging or missed opportunities, thus improving charging efficiency.

In this embodiment, in S40, creating quantitative indicators for user charging satisfaction by taking into account travel time, charging prices, and power consumption comprises:
S41, constructing charging travel time satisfaction for electric vehicle users as follows:

$${f}_{1 , k} = ( 1 - \frac{{T}_{k} - {T}_{min}}{{T}_{max} - {T}_{min}} ) * ( 1 - \frac{{T}_{wait , k}}{{T}_{waitmax}} ) ;$$

where f_{1,k} represents the satisfaction with charging travel time for electric vehicles arriving at charging station k, Tₖ is the travel time for electric vehicles to reach charging station k, Tₘᵢₙ is the shortest travel time to any of the alternative charging stations, Tₘₐₓ is the longest travel time to any of the alternative charging stations, T_{wait,k} is the charging waiting time at charging station k, and T_{waitmax} is the maximum tolerable charging waiting time for electric vehicle users;
S42, constructing charging trip power consumption satisfaction for electric vehicle users as follows:

$${f}_{2 , k} = 1 - \frac{{P}_{lose , k} - {P}_{losemin}}{{P}_{losemax} - {P}_{losemin}} ;$$

where f_{2,k} represents the satisfaction with charging travel time for electric vehicles arriving at charging station k, P_{lose,k} is the power consumption for electric vehicles to reach charging station k, Pₗₒₛₑₘᵢₙ is the minimum power consumption to any of the alternative charging stations, and Pₗₒₛₑₘₐₓ is the maximum power consumption to any of the alternative charging stations;
S43, constructing charging price satisfaction for electric vehicle users as follows:

$${f}_{3 , k} = 1 - \frac{{C}_{k} - {C}_{min}}{{C}_{max} - {C}_{min}} ;$$

where f_{3,k} represents the satisfaction with charging price for charging at charging station k for electric vehicles, Cₖ is the charging price for charging at charging station k for electric vehicles, Cₘᵢₙ is the minimum charging price among all alternative charging stations, and Cₘₐₓ is the maximum charging price among all alternative charging stations; and
S44, constructing comprehensive charging satisfaction indicators for electric vehicle users as follows:

$${f}_{CSR , k} = α {f}_{1 , k} + β {f}_{2 , k} + γ {f}_{3 , k} ;$$

where f_{CSR,k} represents the comprehensive charging satisfaction of electric vehicles at charging station k, which serves as the quantitative indicator for user charging satisfaction, f_{1,k} represents the satisfaction with charging travel time for electric vehicles arriving at charging station k, f_{2,k} represents the satisfaction with charging travel time for electric vehicles arriving at charging station k, f_{3,k} represents the satisfaction with charging price for charging at charging station k for electric vehicles, and α, β and γ are weight coefficients for user charging satisfaction indicators, totaling 1.

By comprehensively considering travel time, power consumption, and electricity prices, a more precise quantitative model for user charging satisfaction has been developed. This model can be adjusted based on different user preferences, making the charging guidance more personalized. By balancing the distribution of users across different charging stations, the resource utilization of charging stations is optimized, preventing waste or unreasonable allocation of resources. Electricity price satisfaction, as an important indicator for users selecting charging stations, effectively guides users to charge during periods or at stations with lower prices and lighter loads. This reduces the pressure on charging stations during peak times, minimizes load fluctuations during peak periods, enhances the stability and safety of the power grid and charging stations, balances charging station loads, and optimizes the operation of the charging network.

As a preferred option for the above embodiment, in S50, proposing charging choice models for different types of electric vehicles based on the quantitative indicators for user charging satisfaction and a charging station queuing system comprises:
S51, assessing the charging demand of private vehicles, including the scenario where, before each trip, if the remaining battery power of the electric vehicle is insufficient to reach the next destination, the user will choose to detour to a charging station for charging, and if fast charging is required during travel between two stops, the private vehicle will detour to charging station k for charging, the assessment of charging demand being as follows:

$${E}_{h , p}^{arrive} < {E}_{p}^{min} ;$$

where

$${E}_{p}^{min}$$

is the minimal power consumption needed to arrive at the nearest charging station to destination p;
S52, assessing the charging demand of ride-hailing vehicles, including the scenario where, ride-hailing vehicles in the process of travel, if the remaining battery power falls below a certain threshold and the ride-hailing vehicle is in an unoccupied state, the ride-hailing vehicle will head to a charging station for charging before picking up passengers, the assessment of charging demand being as follows:

$${E}_{h , p}^{arrive} < {E}_{0 , h} ;$$

where δ is the power coefficient used to determine whether a taxi should charge, and E_{0,h} is the battery capacity of electric vehicle h;
S53, based on the charging demand assessments for private vehicles and ride-hailing vehicles, selecting the most suitable charging station using the quantitative indicators for user charging satisfaction, and calculating charging duration and load demands based on an initial battery level and charging station conditions, the charging duration of electric vehicles being expressed as:

$${T}_{c} = \frac{{E}_{o} - {E}_{ι}}{{η}_{c} {P}_{c}} ;$$

where T_{C} is the charging time of electric vehicles, E_{O} is the ideal state of charge for electric vehicles, Eₜ is the initial state of charge for electric vehicles during charging, η_{C} is the charging efficiency, and P_{C} is the charging power;
the charging load of electric vehicles being expressed as:

$${P}_{k , t} = {\sum }_{h = 1}^{N} {P}_{h , k , t} ;$$

where P_{k,t} is the charging load demand of charging station k in time period t, P_{h,k,t} is the charging load demand of electric vehicle h at charging station k in time period t, and N is the total number of electric vehicles; and
S54, based on the charging duration and load demands, determining, by the charging station queuing system, the order of queuing and charging for electric vehicles based on a first-come, first-served principle.

Based on the relationship between the number of electric vehicles and the number of charging units within the station, there are queues for waiting and for charging. The times of arrival and departure of electric vehicle h at fast-charging station k are recorded in chronological order through sets A={t_{arrive h,k}|h∈[1,Nₖ]} and D={t_{departure h,k}|h∈[1,Nₖ]}, where Nₖ is the number of electric vehicles charging at charging station k. The number of electric vehicles charging at charging station k during each time period may be expressed as:

$$NEV ( k , t ) = n u m ( A , t ) - n u m ( D , t ) ;$$

where NEV(k,t) is the number of electric vehicles requiring charging at charging station k during time period t, and num(A,t) and num(D,t) respectively represent the cumulative number of electric vehicles that have arrived and departed before time t.

When there are available charging piles at the charging station, the charging queue waiting time for electric vehicles is 0; otherwise, the charging queue waiting time is as follows:

$$\{ \begin{matrix}{T}_{w a i t , k} = min {t}_{w} \\ s . t . num ( D , {t}_{h , k}^{a r r i v e} + {t}_{w} ) + {N}_{k}^{p i l e} > n u m ( A , {t}_{h , k}^{a r r i v e} ) , where ( {t}_{h , k}^{a r r i v e} + {t}_{w} ) ∈ D\end{matrix} ;$$

where t_{w} is the remaining charging time of electric vehicles, and

$${N}_{k}^{pile}$$

is the number or charging piles at charging station k.

By assessing the charging demands of private vehicles and ride-hailing vehicles separately, the system can provide personalized charging recommendations for different types of users. Private vehicle users prioritize driving safety and battery assurance, while ride-hailing drivers focus more on charging time and operational efficiency. The system optimizes charging guidance strategies based on these specific needs. This personalized charging guidance effectively enhances the flexibility of the system, meets the actual needs of diverse user groups, and reduces uncertainty in charging decisions.

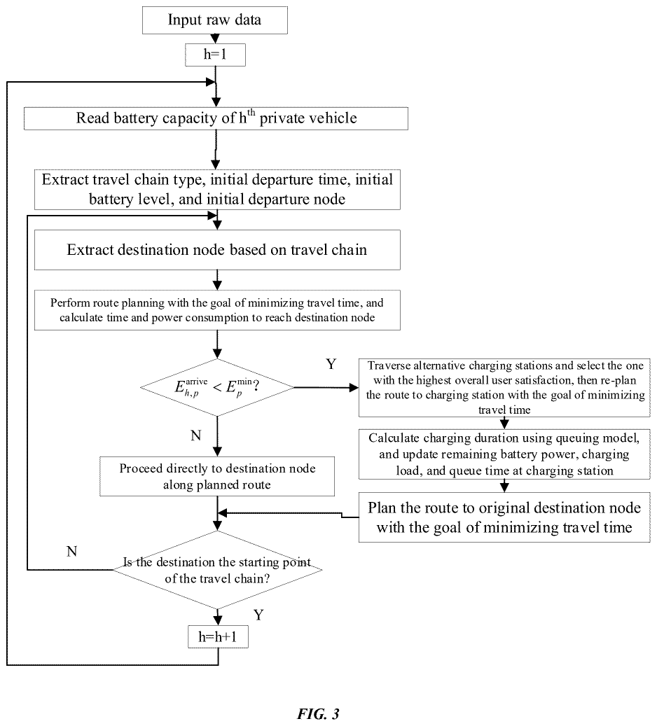

FIG. 3 is a flowchart of private vehicle charging demand prediction, specifically comprising:
initializing and inputting raw data: when the system starts, raw data is input, including vehicle information, charging status and travel plans of private vehicles;
setting initial loop parameters: the loop variable h is initialized to 1, indicating the start of processing data of the first private vehicle;
reading vehicle battery capacity: the battery capacity of the h^{th} private vehicle is retrieved to obtain its current remaining battery power;
extracting travel chain type: based on the historical behavior data or planned itinerary of the vehicle, the travel chain type of the private vehicle is extracted, and the initial departure time, initial battery level, and initial departure node are recorded;
extracting destination node of travel chain: the destination node is extracted from the travel chain for the current trip;
route planning: the system aims to minimize travel time by planning the shortest route from the current departure point to the destination, and based on this route, the time and power consumption for the private vehicle to reach the destination node from the current departure point is calculated;
checking battery level: whether the remaining battery power

$${E}_{h , p}^{arrive}$$

upon reaching the destination node is below the minimum required battery power

$${E}_{p}^{min}$$

for the private vehicle to reach the next destination node is determined;
if yes, the system will plan a detour to the nearest charging station with the highest user satisfaction (considering charging time, electricity price, waiting time, etc.) for charging; after charging, the system will replan a shortest path to continue to the destination node; if no, the system proceeds directly to the destination node according to the original planned route without detouring to a charging station;
checking if the trip is complete: after the vehicle reaches the destination node, the system checks whether it has reached the starting node of the travel chain (indicating whether this travel chain has ended);
if no, updating the travel chain status and continuing processing the next segment of the journey; returning to the step of extracting the travel chain type, extracting the destination of the next segment, and repeating the above steps; if yes, checking if there is data of other vehicles (h) to process; and
processing data of the next private vehicle: if there is more private vehicle data to process, the system increments h by 1, reads the battery capacity of the next vehicle, and repeats the above steps; and if the journeys of all vehicles have been processed, the flow ends.

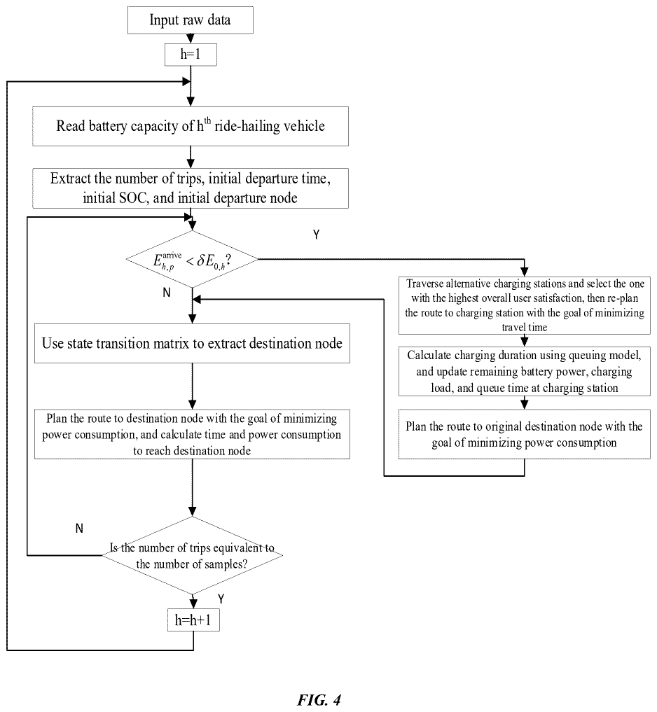

FIG. 4 is a flowchart of ride-hailing vehicle charging demand prediction, specifically comprising:
inputting raw data: the system first inputs raw data of ride-hailing vehicles, including battery capacity, travel records, and other information;
setting loop parameters: the loop variable h is initialized to 1, indicating the start of processing data of the first ride-hailing vehicle;
reading vehicle battery capacity: the battery capacity of the h^{th} ride-hailing vehicle is retrieved to obtain its current remaining battery power;
extracting number of trips and initial state: the system extracts the number of trips, the initial departure time, the initial State of Charge (SOC), and the initial departure node for the ride-hailing vehicle, and records the current battery capacity and location of the vehicle to prepare for subsequent planning;
checking if remaining battery power is below threshold: whether the remaining battery power

$${E}_{h , p}^{arrive}$$

of the ride-hailing vehicle is below a battery level threshold δE_{0,h} (minimum battery level) is determined;
if yes, it indicates insufficient charge, the system automatically enters a charging mode, planning for the vehicle to go to a suitable charging station with the highest user satisfaction for charging and optimizing the charging strategy; if no, it indicates sufficient charge, the system continues to plan the next segment of the journey;
extracting destination node based on state transition matrix: by using a state transition matrix model, the system extracts the next destination node for the ride-hailing vehicle, and performs dynamic planning based on the operation mode of the ride-hailing vehicle and the state transition matrix;
route planning and energy consumption calculation: aiming to minimize energy consumption during route planning, the system determines the optimal driving route from the current node to the destination node, and calculates the time and power consumption required for the ride-hailing vehicle to reach the destination node;
checking if the number of trips has reached a predetermined value: the system checks whether the current number of trips of the ride-hailing vehicle equals a preset sampling count;
if no, the system continues to execute the next trip operation by returning to the step of extracting the destination node based on the state transition matrix to continue to extract the next destination node, and performing route planning and energy consumption calculation; if yes, the charging demand prediction process for the current ride-hailing vehicle concludes; and
processing data of the next ride-hailing vehicle: if there is more ride-hailing vehicle data to process, the system increments h by 1, reads the battery capacity of the next vehicle, and repeats the above steps; and if the data of all vehicles has been processed, the flow ends.

As a preferred option for the above embodiment, in S60, based on the charging choice models and the charging station queuing system, predicting charging loads at charging stations during various time periods and proposing a dynamic pricing strategy with the goal of minimizing load fluctuations at the charging stations comprises:
S61, constructing a charging station load prediction model to obtain a predicted charging load for each charging station, the model comprising:

$${L}_{k , t + 1}^{predict} = {L}_{k , t}^{arrive} + {L}_{k , t}^{charge} + {L}_{k , t}^{decide} - {L}_{k , t + 1}^{departure} ;$$

where

$${L}_{k , t + 1}^{predict}$$

represents the predicted load demand of charging station k during time period t+1,

$${L}_{k , t}^{arrive}$$

represents the new load added to charging station k during time period t,

$${L}_{k , t}^{charge}$$

represents the in-station charging load of charging station k during time period t,

$${L}_{k , t}^{decide}$$

represents the load that decides to charge at charging station k during time period t, and

$${L}_{k , t + 1}^{departure}$$

represents the load that cancels charging at charging station k during time period t+1;
S62, based on the maximum charging load capacity that each charging station is able to accommodate, normalizing the predicted charging load for each charging station to the maximum capacity, and calculating an average predicted load for the charging stations;
S63, when a difference between the predicted charging load for each charging station and the average predicted load is less than or greater than an adjustment threshold, adjusting the charging prices at the charging stations; and
S64, based on the adjustment to the charging prices at the charging stations, optimizing a charging price adjustment step size Δcₖ using a particle swarm optimization algorithm with a compression factor. This ensures that price regulation can effectively guide users to disperse to charging stations with lower loads when there are significant load differences among stations, thereby reducing load fluctuations.

Through reasonable load prediction and dynamic pricing adjustment, the system can effectively prevent excessive charging behavior during peak periods, minimize the impact of charging peaks on the power distribution network, ensure the stable operation of the power distribution network, and reduce the load on the grid during peak times. This avoids the pressure on the grid caused by concentrated demand for fast charging, enhancing the overall stability and safety of the grid. Additionally, through load prediction and price adjustment, the system can allocate charging station resources reasonably, reducing user queueing and waiting times during peak periods, improving the efficiency of the overall charging process, and enhancing the user experience. This also increases the overall operational efficiency of the system, allowing charging stations to operate in a more efficient environment.

In S62, a model for calculating an average predicted load for the charging stations comprises:

$${L}_{mean , t}^{predict} = \frac{{\sum }_{k = 1}^{K} {L}_{k , t}^{predict} {σ}_{k}}{K} ;$$

$${σ}_{k} = \frac{max \{ {q}_{1} , {q}_{2} , … , {q}_{K} \}}{{q}_{k}} ;$$

where

$${L}_{mean , t}^{predict}$$

is the average predicted load demand for time period t,

$${L}_{k , t}^{predict}$$

is the predicted load demand for charging station k during time period t, σₖ is the normalization factor for charging station k, which equals 1 when the charging load capacity of charging station k is equal to the maximum charging load capacity among all charging stations, K is the total number of charging stations, and qₖ is the number of charging piles within charging station k.

By predicting the load of charging stations and calculating the average load, the system can identify which stations may exceed safety load thresholds earlier, allowing for proactive adjustment. This not only optimizes the load distribution of charging stations but also prevents excessive loads from stressing the power distribution network, ensuring its stable operation. It reduces the load fluctuation pressure caused by fast charging of electric vehicles, safeguarding the operational safety of the grid and enhancing the overall stability of the power supply system. Through load prediction and reasonable price adjustment, users can more accurately select charging stations with lower loads, thereby reducing waiting times. The system can alleviate congestion at charging stations during peak periods by dynamically adjusting price and load distribution, improving users' charging efficiency and overall experience. This minimizes waiting times for users during peak hours, optimizes the charging experience, and enhances the service quality of the charging system.

In this embodiment, in S63, when a difference between the predicted charging load for each charging station and the average predicted load is less than or greater than an adjustment threshold, a model for adjusting the charging prices at the charging stations comprises:

$${C}_{k , t} = \{ \begin{matrix}{C}_{k , t} + Δ {c}_{k} & {L}_{k , t}^{predict} {σ}_{k} - {L}_{mean , t}^{predict} > ε {L}_{mean , t}^{predict} \\ {C}_{k , t} & \vert {L}_{k , t}^{predict} {σ}_{k} - {L}_{mean , t}^{predict} \vert , , ε {L}_{mean , t}^{predict} \\ {C}_{k , t} - Δ {c}_{k} & {L}_{k , t}^{predict} {σ}_{k} - {L}_{mean , t}^{predict} < - ε {L}_{mean , t}^{predict}\end{matrix} ;$$

where C_{k,t} is the charging price for charging station k during time period t, Δcₖ is the charging price adjustment step size, ε is the dead-time coefficient,

$${L}_{mean , t}^{predict}$$

is the average predicted load demand for time period t,

$${L}_{k , t}^{predict}$$

is the predicted load demand for charging station k during time period t, and ox is the normalization factor for charging station k, which equals 1 when the charging load capacity of charging station k is equal to the maximum charging load capacity among all charging stations.

Through dynamic price adjustment, the system can effectively guide users to charge during periods of lighter load, reducing the pressure on the grid during peak times and ensuring grid stability. This balances the charging demand of electric vehicles with fluctuations in grid load, making the charging process smoother and more efficient. It minimizes the impact of charging peaks on the grid, enhancing overall stability and ensuring a dynamic balance between electric vehicle charging needs and grid load. By employing a price adjustment model based on load prediction, the system can provide users with real-time and accurate price information, helping them make more rational charging choices. Users can select the most suitable charging stations and time slots based on dynamic changes in load and price, thereby lowering charging costs. This improves the intelligence of user charging decisions, helping users reduce costs and enhance charging efficiency and overall experience.

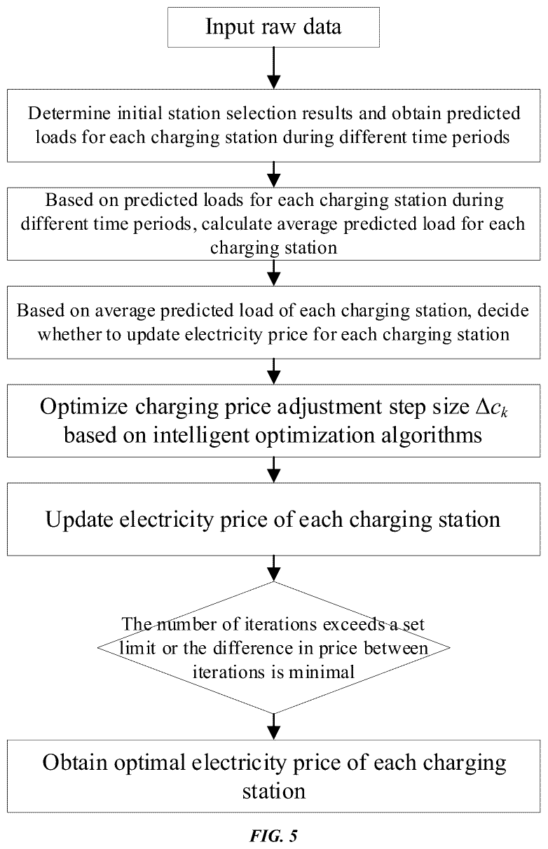

FIG. 5 is a flowchart of a dynamic pricing process for charging stations, specifically comprising:
inputting raw data: the system first inputs the raw data of charging stations, including real-time load, historical data, current electricity price, and other basic information of each charging station;
determining initial station selection result: based on the input data, the system determines the initial status of each charging station and calculates the predicted loads of each station during different time periods;
obtaining predicted loads of each charging station during different time periods: according to the initial station selection result, the system calculates the predicted loads of each charging station during various time periods, generating load prediction for each period based on historical data and current electric vehicle charging demands;
obtaining average predicted load of charging stations based on predicted loads during different time periods: the system aggregates the load for each time period to calculate the average predicted load of the charging stations, and this step helps standardize the loads of charging stations with different capacities, allowing subsequent price adjustment to be based on a unified standard;
determining whether to update price based on average predicted load of charging stations: the system compares the current load of each charging station with its average predicted load to assess whether the current load exceeds or falls below an adjustment threshold; if the load fluctuations are significant, the electricity price at charging stations needs to be adjusted;
calculating and optimizing charging price adjustment step size Δck based on intelligent optimization algorithm: the system uses an intelligent optimization algorithm (such as particle swarm optimization algorithm) to calculate and optimize the price adjustment step size Δck, ensuring that the price changes are reasonable and avoiding excessively large or small adjustment that could lead to irrational user behavior;
updating price of each charging station: based on optimization results, the system updates the price of each charging station to align with real-time load levels, guiding users to rationally disperse their charging demands;
loop judgment: the system checks whether the current loop has exceeded the predetermined number of iterations or if the difference between two consecutive price updates is minimal; if so (for example, if the optimal price is reached or price changes have stabilized), the loop ends; otherwise, the system returns to the step of obtaining the predicted loads of each charging station during different time periods and continues with price optimization; and
obtaining optimal price of each charging station: after multiple iterations of optimization, the system derives the optimal price of each charging station under different load conditions, ensuring a balanced load across charging stations and optimizing resource utilization.

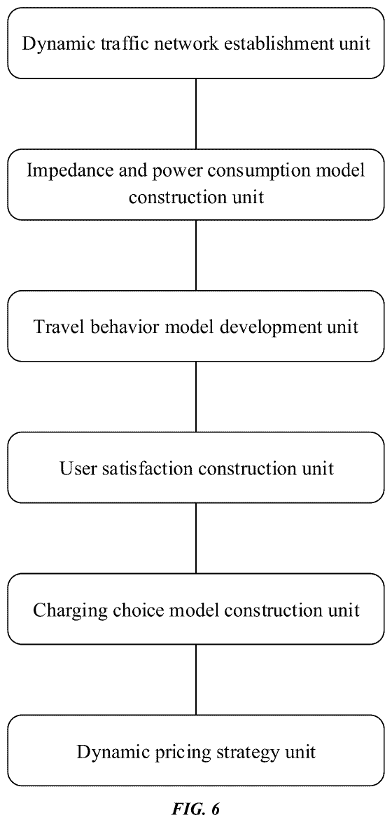

The invention further provides a fast-charging demand guidance apparatus for guiding the charging preferences of electric vehicle users, which uses the method as described above. As shown in FIG. 6, the guidance apparatus comprises:
a dynamic traffic network establishment unit for acquiring information on roads, traffic, and charging stations to establish a dynamic traffic network with real-time updates;
an impedance and power consumption model construction unit for constructing a road traffic impedance model and an electric vehicle power consumption model by utilizing the dynamic traffic network and taking into account the road travel time and speed of electric vehicles under different traffic conditions;
a travel behavior model development unit for simulating the travel behavior of electric vehicles based on the road traffic impedance model and the electric vehicle power consumption model, classifying electric vehicles into private vehicles and ride-hailing vehicles based on different travel patterns, and developing a private vehicle travel behavior model and a ride-hailing vehicle travel behavior model;
a user satisfaction construction unit for creating quantitative indicators for user charging satisfaction by utilizing the private vehicle travel behavior model and the ride-hailing vehicle travel behavior model and taking into account travel time, charging prices, and power consumption;
a charging choice model construction unit for proposing charging choice models for different types of electric vehicles based on the quantitative indicators for user charging satisfaction and a charging station queuing system; and
a dynamic pricing strategy unit for, based on the charging choice models and the charging station queuing system, predicting charging loads at charging stations during various time periods and proposing a dynamic pricing strategy with the goal of minimizing load fluctuations at the charging stations.

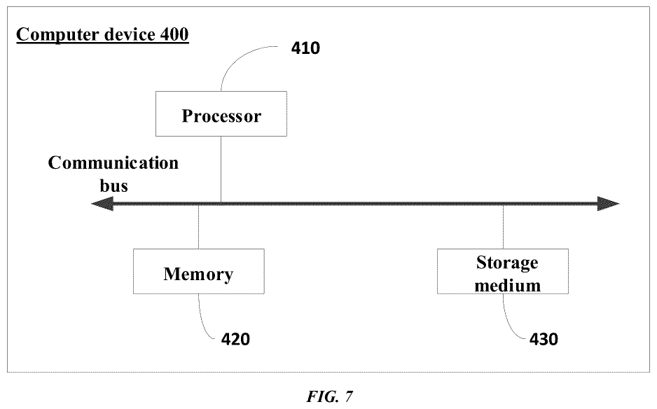

Refer to the structural diagram of a computer device provided by an embodiment of the application shown in FIG. 7. The computer device 400 provided by the embodiment of the application comprises a processor 410 and a memory 420, the memory 420 stores a computer program executable by the processor 410, and when the computer program is executed by the processor 410, the above method is implemented.

An embodiment of the application further provides a storage medium 430 on which a computer program is stored, and the computer program, when executed by the processor 410, implements the method as described above.

The storage medium 430 may be realized by any type of volatile or nonvolatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

In the description of the invention, the terms “first” and “second” are only used for descriptive purposes, and cannot be understood as indicating or implying relative importance or implicitly indicating the number of indicated technical features. Therefore, the features defined with “first” and “second” may include one or more of the features explicitly or implicitly. “Multiple” means two or more, unless otherwise specifically defined.

In the present invention, unless otherwise specified and defined, the terms “mount”, “connect” and “fix” should be understood in a broad sense. For example, it can be fixed connection, detachable connection or integrated connection; it can be mechanical connection or electric connection; and it can be direct connection, indirect connection through intermediate media or internal communication or interaction of two elements. For those of ordinary skill in the art, the specific meaning of the terms mentioned above in the present invention should be construed to specific circumstances.

In the description of this specification, terms such as “an embodiment”, “some embodiments”, “example”, “specific example” or “some examples” indicate that the specific features, structures, materials, or characteristics described in conjunction with that embodiment or example are included in at least one embodiment or example of the invention. In this specification, the indicative statements regarding the above-mentioned terms do not necessarily refer to the same embodiment or example. Moreover, the specific features, structures, materials, or characteristics described can be combined in a suitable manner in any one or more embodiments or examples. In addition, those skilled in the art can integrate and combine different embodiments or examples and features of different embodiments or examples described in this specification without contradicting each other.

Any process or method description in the flowchart or otherwise described herein can be understood as representing a module, segment or part of code that includes one or more executable instructions for implementing specific logical functions or steps of the process, and the scope of preferred embodiments of the present invention includes other implementations, in which functions can be performed out of the order shown or discussed, including in a substantially simultaneous manner or in the reverse order according to the functions involved, which should be understood by those skilled in the technical field to which embodiments of the present invention belong.

The logic and/or steps represented in the flowchart or described in other ways herein, for example, can be regarded as a sequenced list of executable instructions for realizing logical functions, and can be embodied in any computer-readable medium for use by or in combination with an instruction execution system, apparatus or device (such as a computer-based system, a system including a processor or other systems that can fetch instructions from and execute instructions from the instruction execution system, apparatus or device). For the purposes of this specification, a “computer-readable medium” can be any apparatus that can contain, store, communicate, propagate or transmit a program for use by or in connection with an instruction execution system, apparatus or device. More specific examples (non-exhaustive list) of computer-readable media include the following: an electrical connection part (electronic apparatus) with one or more wires, a portable computer disk box (magnetic apparatus), a random access memory (RAM), a read-only memory (ROM), an erasable and editable read-only memory (EPROM or flash memory), an optical fiber apparatus, and a portable CD-ROM. In addition, the computer-readable medium may even be paper or other suitable medium on which the program can be printed, because the program can be obtained electronically by, for example, optically scanning the paper or other medium, followed by editing, interpreting or processing in other suitable ways if necessary, and then stored in a computer memory.

It should be understood that various parts of the present invention can be implemented in hardware, software, firmware or a combination thereof. In the above embodiments, a plurality of steps or methods can be realized by software or firmware stored in a memory and executed by an appropriate instruction execution system. For example, if it is implemented in hardware, as in another embodiment, it can be implemented by any one of the following technologies or their combination: a discrete logic circuit with a logic gate for implementing a logic function on a data signal, an application specific integrated circuit with a suitable combinational logic gate, a programmable gate array (PGA), a field programmable gate array (FPGA), and the like.

Those skilled in the art can understand that all or part of the steps carried by the method of the above embodiment can be completed by instructing related hardware through a program, which can be stored in a computer-readable storage medium, and the program, when executed, includes one or a combination of the steps of the method embodiment.

The storage medium mentioned above can be read-only memory, magnetic disk or optical disk, etc. Although the embodiments of the present invention have been shown and described above, it can be understood that the above embodiments are exemplary and cannot be understood as limitations of the present invention, and those skilled in the art can make changes, modifications, substitutions and variations to the above embodiments within the scope of the present invention.

1. A non-transitory computer-readable medium on which a computer program is stored, wherein the computer program implements a method for guiding fast charging demands of electric vehicles, comprising:
S10, acquiring information on roads, traffic, and charging stations to establish a dynamic traffic network with real-time updates;
S20, constructing a road traffic impedance model and an electric vehicle power consumption model by utilizing the dynamic traffic network and taking into account the road travel time and speed of electric vehicles under different traffic conditions;
S30, simulating the travel behavior of electric vehicles based on the road traffic impedance model and the electric vehicle power consumption model, classifying electric vehicles into private vehicles and ride-hailing vehicles based on different travel patterns, and developing a private vehicle travel behavior model and a ride-hailing vehicle travel behavior model;
S40, creating quantitative indicators for user charging satisfaction by utilizing the private vehicle travel behavior model and the ride-hailing vehicle travel behavior model and taking into account travel time, charging prices, and power consumption;
S50, providing charging choice models for different types of electric vehicles based on the quantitative indicators for user charging satisfaction and a charging station queuing system; and
S60, based on the charging choice models and the charging station queuing system, predicting charging loads at charging stations during various time periods and providing a dynamic pricing strategy that minimizes load fluctuations at the charging stations, users being guided to charge during off-peak hours through price regulation, thereby balancing the charging loads among charging stations, reducing a power fluctuation pressure on a power distribution network caused by fast charging, and ensuring the stable operation of a power grid,
wherein in S60, based on the charging choice models and the charging station queuing system, predicting charging loads at charging stations during various time periods and providing the dynamic pricing strategy with the goal of minimizing load fluctuations at the charging stations comprises:
S61, constructing a charging station load prediction model to obtain a predicted charging load for each charging station;
S62, based on the maximum charging load capacity that each charging station is able to accommodate, normalizing the predicted charging load for each charging station to the maximum capacity, and calculating an average predicted load for the charging stations;
S63, when a difference between the predicted charging load for each charging station and the average predicted load is less than or greater than an adjustment threshold, adjusting the charging prices at the charging stations; and
S64, based on the adjustment to the charging prices at the charging stations, optimizing a charging price adjustment step size using a particle swarm optimization algorithm with a compression factor;
wherein in S62, a model for calculating an average predicted load for the charging stations comprises:
$${L}_{mean , t}^{predict} = \frac{{\sum }_{k = 1}^{K} {L}_{k , t}^{predict} {σ}_{k}}{K} ;$$
$${σ}_{k} = \frac{max \{ {q}_{1} , {q}_{2} , … , {q}_{K} \}}{{q}_{k}} ;$$
where
$${L}_{mean , t}^{predict}$$
is the average predicted load demand for time period t,
$${L}_{k , t}^{predict}$$
is the predicted load demand for charging station k during time period t, σₖ is the normalization factor for charging station k, which equals 1 when the charging load capacity of charging station k is equal to the maximum charging load capacity among all charging stations, K is the total number of charging stations, and qₖ is the number of charging piles within charging station k; and
wherein in S63, when a difference between the predicted charging load for each charging station and the average predicted load is less than or greater than an adjustment threshold, a model for adjusting the charging prices at the charging stations comprises:
$${C}_{k , t} = \{ \begin{matrix}{C}_{k , t} + Δ {c}_{k} & {L}_{k , t}^{predict} {σ}_{k} - {L}_{mean , t}^{predict} > ε {L}_{mean , t}^{predict} \\ {C}_{k , t} & \vert {L}_{k , t}^{predict} {σ}_{k} - {L}_{mean , t}^{predict} \vert \tilde{N} ε {L}_{mean , t}^{predict} \\ {C}_{k , t} - Δ {c}_{k} & {L}_{k , t}^{predict} {σ}_{k} - {L}_{mean , t}^{predict} < - ε {L}_{mean , t}^{predict}\end{matrix} ;$$
where C_{k,t} is the charging price for charging station k during time period t, Δcₖ is the charging price adjustment step size, ε is the dead-time coefficient,
$${L}_{mean , t}^{predict}$$
is the average predicted load demand for time period t,
$${L}_{k , t}^{predict}$$
is the predicted load demand for charging station k during time period t, and σₖ is the normalization factor for charging station k, which equals 1 when the charging load capacity of charging station k is equal to the maximum charging load capacity among all charging stations.

2. The non-transitory computer-readable medium according to claim 1, wherein in S20, the road traffic impedance model comprises:
$${R}_{l} = \frac{2 {T}_{0 , l} ( 1 + \sqrt{1 + \frac{{Q}_{l}}{{C}_{l}}} )}{\frac{{Q}_{l}}{{C}_{l}}} + τ ( \frac{{L}_{l}}{{N}_{l}} ) ;$$
where Rₗ is the total travel time for road segment l, T_{0,l} is the travel time for road segment l when it is clear, Q₁ is the traffic volume on road segment l, Cₗ is the actual traffic capacity of road segment l, Lₗ is the length of road segment l, Nₗ is the number of roadside vehicles on road segment l, and τ is the influence coefficient of roadside vehicles on the traffic flow of road segment.

3. The non-transitory computer-readable medium according to claim 1, wherein in S20, the electric vehicle power consumption model comprises:
$${E}_{lose , l} = {L}_{l} ( a - {bV}_{l} + \frac{c}{{V}_{l}} ) ;$$
where E_{lose,l} is the power consumption of electric vehicles on road segment l, Vₗ is the average speed of electric vehicles traveling on road segment l, with different speeds corresponding to different road grades and conditions, Lₗ is the length of road segment l, and a, b and c are power consumption coefficients.

4. The non-transitory computer-readable medium according to claim 1, wherein in S30, classifying electric vehicles into private vehicles and ride-hailing vehicles based on different travel patterns and developing a private vehicle travel behavior model and a ride-hailing vehicle travel behavior model comprises:
S31, determining the travel behavior of private vehicles, including the use of travel chains that start and end at residential areas to describe the travel behavior of private vehicles, the first travel time and duration for each type of travel chain following a normal distribution;
S32, determining the travel behavior of ride-hailing vehicles, including the use of a travel state transition matrix to describe the travel behavior of ride-hailing vehicles, the first travel time and number of trips for ride-hailing vehicles also following a normal distribution;
S33, based on the travel behavior of private vehicles and the travel behavior of ride-hailing vehicles, planning routes for private vehicles and ride-hailing vehicles, specifically comprising:
planning routes for private vehicles with the aim of minimizing driving time; and
planning routes for ride-hailing vehicles with the aim of minimizing electric vehicle travel distance during passenger trips, and minimizing electric vehicle energy consumption or driving time during empty trips; and
S34, based on the planned routes for private vehicles and ride-hailing vehicles, calculating the arrival time and remaining battery power for electric vehicles.

5. The non-transitory computer-readable medium according to claim 4, wherein in S34, a model for calculating the arrival time and remaining battery power for electric vehicles comprises:
$${t}_{h , p}^{arrive} = {t}_{h , p - 1}^{leave} + {\sum }_{( i , j ) ∈ {Ω}_{p - 1 , p}} {t}_{i , j}^{travel} ;$$
$${E}_{h , p}^{arrive} = {E}_{h , p - 1}^{leave} + {\sum }_{( i , j ) ∈ {Ω}_{p - 1 , p}} {E}_{lose , i , j} ;$$
where
$${t}_{h , p}^{arrive}$$
is the time when the h^{th} electric vehicle arrives at activity location p,
$${t}_{h , p - 1}^{leave}$$
is the time when the h^{th} electric vehicle departs from activity location p−1,
$${t}_{i , j}^{travel}$$
is the travel time for the road segment from node i to node j, Ω_{p-1,p} is a set of road segments on the path from activity location p−1 to activity location p,
$${E}_{h , p}^{arrive}$$
is the remaining battery power of the h^{th} electric vehicle when it arrives at activity location p,
$${E}_{h , p - 1}^{leave}$$
is the remaining battery power of the h^{th} electric vehicle when it departs from activity location p−1, and E_{lose,i,j} is the power consumption for the road segment from node i to node j.

6. The non-transitory computer-readable medium according to claim 1, wherein in S40, creating quantitative indicators for user charging satisfaction by taking into account travel time, charging prices, and power consumption comprises:
$${f}_{CSR , k} = α {f}_{1 , k} + β {f}_{2 , k} + γ {f}_{3 , k} ;$$
where f_{CSR,k} represents the comprehensive charging satisfaction of electric vehicles at charging station k, f_{1,k} represents the satisfaction with charging travel time for electric vehicles arriving at charging station k, f_{2,k} represents the satisfaction with charging travel time for electric vehicles arriving at charging station k, f_{3,k} represents the satisfaction with charging price for charging at charging station k for electric vehicles, and α, β and γ are weight coefficients for user charging satisfaction indicators, totaling 1.

7. The non-transitory computer-readable medium according to claim 1, wherein in S50, providing charging choice models for different types of electric vehicles based on the quantitative indicators for user charging satisfaction and a charging station queuing system comprises:
S51, assessing the charging demand of private vehicles, including the scenario where, before each trip, if the remaining battery power of the electric vehicle is insufficient to reach the next destination, the user will choose to detour to a charging station for charging, and if fast charging is required during travel between two stops, the private vehicle will detour to a charging station for charging;
S52, assessing the charging demand of ride-hailing vehicles, including the scenario where, ride-hailing vehicles in the process of travel, if the remaining battery power falls below a certain threshold and the ride-hailing vehicle is in an unoccupied state, the ride-hailing vehicle will head to a charging station for charging before picking up passengers;
S53, based on the charging demand assessments for private vehicles and ride-hailing vehicles, selecting the most suitable charging station using the quantitative indicators for user charging satisfaction, and calculating charging duration and load demands based on an initial battery level and charging station conditions; and
S54, based on the charging duration and load demands, determining, by the charging station queuing system, the order of queuing and charging for electric vehicles based on a first-come, first-served principle.

8. (canceled)

9. (canceled)

10. (canceled)

11. An apparatus for guiding fast charging demands of electric vehicles, using the non-transitory computer-readable medium according to claim 1, comprising:
a dynamic traffic network establishment unit for acquiring information on roads, traffic, and charging stations to establish a dynamic traffic network with real-time updates;
an impedance and power consumption model construction unit for constructing a road traffic impedance model and an electric vehicle power consumption model by utilizing the dynamic traffic network and taking into account the road travel time and speed of electric vehicles under different traffic conditions;
a travel behavior model development unit for simulating the travel behavior of electric vehicles based on the road traffic impedance model and the electric vehicle power consumption model, classifying electric vehicles into private vehicles and ride-hailing vehicles based on different travel patterns, and developing a private vehicle travel behavior model and a ride-hailing vehicle travel behavior model;
a user satisfaction construction unit for creating quantitative indicators for user charging satisfaction by utilizing the private vehicle travel behavior model and the ride-hailing vehicle travel behavior model and taking into account travel time, charging prices, and power consumption;
a charging choice model construction unit for providing charging choice models for different types of electric vehicles based on the quantitative indicators for user charging satisfaction and a charging station queuing system; and
a dynamic pricing strategy unit for, based on the charging choice models and the charging station queuing system, predicting charging loads at charging stations during various time periods and providing a dynamic pricing strategy with the goal of minimizing load fluctuations at the charging stations.

12. (canceled)

13. (canceled)
